(19) United States
(12) Patent Application Publication
(10) Pub. No.: US 2024/0337994 A1
(43) Pub. Date: Oct. 10, 2024

(54) Human Operable Controller

(71) Applicant: Input Labs Oy, Helsinki (FI)

(72) Inventors: Marcos Diaz, Helsinki (FI); Michael Przybilski, Helsinki (FI)

(21) Appl. No.: 18/244,330

(22) Filed: Sep. 11, 2023

(30) Foreign Application Priority Data
Apr. 6, 2023 (FI) 20237064

(51) Int. Cl. G05B 15/02; G01C 19/5776; G01P 3/44

(52) U.S. Cl. CPC G05B 15/02; G01C 19/5776; G01P 3/44

(57) ABSTRACT

There is provided a human operable controller device and method for the controller device, wherein the controller comprises: a first sensor arrangement for measuring angular rate of the controller for at least one axis to provide a first measurement data; a second sensor arrangement for measuring angular rate of the controller for said at least one axis to provide a second measurement data; a processing circuitry for generating a control signal representing angular rate of the controller for said at least one axis based on the first measurement data and the second measurement data; and a communication interface for coupling with the external computer system and for providing the control signal to the external computer system to control the application.

### TECHNICAL FIELD

Various example embodiments are generally related to human operable controllers. More particularly, the embodiments relate to mechanisms for controlling an application on external computer system based on angular rate of the mechanism.

### BACKGROUND

Human operable controllers, herein referred to simply as controllers, are used to provide a control signal to control the execution of an application or applications run on an external computer system. The controller may be a device (e.g. controller device) or an apparatus (e.g. controller apparatus) or a part of a device or an apparatus. The controller may comprise means for generating the control signal based on e.g. movement of the controller. For example, game or drone controllers can be used for such purpose. One particularly interesting aspect is the use of the change in angular rate of the controller for generating the control signal. That is, by e.g. tilting the controller, angular rate caused by the tilting may be measured and the control signal can be generated to represent the angular rate. Thus, the control signal may be generated based on the measured angular rate and used to control the execution of the application. Such control signal may thus be understood to mimic the actual angular movement of the controller. In some examples, the control signal may be understood to represent the change in angular rate of the controller.

As with many other measurements, the measured angular rate and actual angular rate may differ from actual movement, as measurements may cause errors caused by e.g. noise, scaling issues and/or zero-rate drift. Thus, the measured angular rate used as a basis for generating the control signal may not optimally represent the actual angular rate caused by the user's actions. Thus, it may be beneficial to develop solutions to measure the angular rate to reduce or mitigate at least some of the aforementioned errors.

### BRIEF DESCRIPTION

According to some aspects, there is provided the subject matter of the independent claims. Some further aspects are defined in the dependent claims.

### LIST OF THE DRAWINGS

In the following, the invention will be described in greater detail with reference to the embodiments and the accompanying drawings, in which

FIG. 1 presents a system including controller and computer system according to an embodiment;

FIG. 2 shows block diagram of a system including controller and computer system according to an embodiment;

FIGS. 3A and 3B illustrate flow diagrams according to some embodiments;

FIG. 4A represents actual angular rate of controller;

FIGS. 4B, 4C, and 4D illustrate some embodiments for measuring angular rate;

FIG. 5 illustrates an example embodiment;

FIGS. 6A and 6B illustrate some examples for multisampling with one sensor;

FIGS. 6C and 6D illustrate some embodiments for mitigating noise by utilizing multiple sensors for multisampling, using the average function as example; and

FIG. 7 illustrates a block diagram according to an example embodiment.

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. For the purposes of the present disclosure, the phrases “A or B” and “A and/or B” means (A), (B), or (A and B). For the purposes of the present disclosure, the phrase “A, B, and/or C” means (A), (B), (C), (A and B), (A and C), (B and C), or (A, B, and C).

Redundant sensors (with equivalent characteristics) used in critical systems (aviation, medical) may increase reliability of a system in case of failure, but the individual characteristics of each sensor remain the same. On the other hand, it is common to find multiple sensors of different nature used in consumer electronics, complementing each other to obtain better results (sensor fusion). An example of this is a smartphone combining GPS data and motion sensor data to reduce the uncertainty of location. However, in the field of controllers (sometimes referred to as controller devices), such sensor fusion has been less of a topic of interest.

As for today, most angular rate sensors available may be, for example, categorized into two groups. The first group comprises consumer electronics Inertial Measurement Units (IMUs), sometimes with both accelerometer and Angular Rate Sensor (ARS) in a single chip, used in devices such as smartphones and videogame peripherals. These are based on the piezoelectric effect, are small, relatively inexpensive, and are energy efficient. Due to their small size, their performance characteristics (e.g. noise, zero-rate, and/or scale) are limited, but possibly enough for their intended use such as smartphone tilt detection, step-counter, and/or mobile videogame input.

The second group comprises industrial-grade or aerospace-grade motion sensor devices, such as ring laser gyroscopes (Sagnac effect) and Dynamically Tuned Gyroscope (DTG) rotor gimbals. These achieve very precise readings but are expensive and big, not suited for consumer electronics.

Smartphone-grade IMUs prioritize small footprint and low energy consumption in their design, while performance characteristics such as signal-to-noise ratio and zero-rate (drift) are only secondary. The miniaturized parts featuring the piezoelectric effect are prone to have high relative noise (compared with other common input methods such as a mouse optoelectronic sensor); and small variations in temperature cause an offset in their readings within a noticeable range.

Some examples of these novel applications, that may require higher motion sensing performance than those provided by low-tier IMUs, may be Virtual Reality (VR), Augmented Reality (AR), and/or Extended Reality (XR). In some examples, the VR/AR/XR related applications are used in the domain of videogames, in which controlling is usually done by using both hands, each hand having an independent device featuring infrared spatial tracking, so the angle can be derived from the position of the hands in 3D space. Some other examples may relate to Augmented Reality (AR) applications or Extended Reality (XR) applications. Videogame controllers (Sony PlayStation DualShock, Steam Controller, Nintendo Switch Joy-Cons etc.) have also been featuring motion sensors, but they were never used as a primary method for controlling an application due to the limitations of these smartphone-grade IMUs; and instead, only using angular rate data as secondary input method to complement thumbstick or trackpad primary input.

Another example of applicable field may be controllers for controlling movement of a drone or similar vehicle (e.g. unmanned aerial vehicle (UAV)). Higher precision and lower latency may be beneficial when controlling an expensive and potentially dangerous flying vehicle.

As a third example, computer mouse or similar control device can potentially be mounted with motion sensor for providing a control signal. For example, users with limited hand movement may benefit from new types of control devices that can accurately detect controller tilts (or angular rate) and use such data to provide the control signal to the application currently in use. These examples should be understood as possible implementations. However, the embodiments of the present solution may be used in other fields too.

Some examples of error causes may include noise, sensor scale-related errors and zero-rate drift. Noise is the unintended random disturbance on a signal. In commercially available ARSs noise may be measured in mdps/\sqrt{Hz} (i.e. milli-degree per second by square root of frequency). It is not trivial to do a fair comparison with other common computer input methods such as mouse optoelectronic sensors, since these are a combination of camera and image processing hardware/software that effectively reduces noise to zero on the resulting output. In practical terms, when using an optoelectronic sensor mouse for controlling a computer mouse cursor, noise may be a non-factor; but when using commercially available ARS(s) (using a reasonable Degrees Per Second (DPS) scale and operating system sensitivity) the noise can cause the mouse cursor to jitter several pixels back and forth at high frequency, thus making it unfit for the purpose unless applying filtering techniques with significant trade-offs in latency (smoothing) or linearity (acceleration).

Noise may be reduced using one or more of the following techniques:
Frequency filtering: Either via hardware or software, to reduce the amplitude of undesired frequencies. Usually removing frequencies that are much higher or much lower than what the user is expected to input as real signal. By definition such operation cannot remove noise in the frequency range of real input, or it would be filtering out such input.
Multisampling: Since noise is a random value within a range, averaging the value of samples over time approximates the result to zero, the more samples the more reduction of noise, but with the trade-off of increased latency, which is also an undesired attribute as it may cause lag between tilting the controller and actual action at the intended target.
Acceleration: By applying an exponential response curve, the parts of the signal with low amplitude are reduced further, including noise. In applications in which linearity is required to achieve consistent results, this is a undesired trade-off.

Angular rate sensors may have a limit in the turn rate they can report. These may be measured in maximum DPS until they saturate their data channel. For commercially available ARSs this attribute can be configured, usually in predefined steps from 125 DPS to 4000 DPS, referred as ranges or scales (or sensing scales). There are trade-offs depending on which scale is chosen: smaller scales may have better granularity (lower DPS per Least Significant Bit), better signal-to-noise ratio, and smaller zero-rate ratio, but can only report on slower turns or tilts. Sensors with bigger scales, on the other hand, can report on faster turns or tilts, but may have worse granularity, worse noise-signal ratio, and greater zero-rate.

Since noise and zero-rate (drift) in ARSs are not negligible, these trade-offs can be problematic no matter the chosen scale. One potential solution is to change the scale dynamically when the current range is too small or too big. But such request to the IMU may be relatively slow and a blocking operation, so no reading from the sensor can be taken while the scale is being adjusted. Therefore, this method cannot be employed if the system is expecting continuous readings with a smaller interval than the time it takes to change the scale.

Zero-rate (also known as random walk offset or drift (i.e. zero-rate drift)) is a deviation over time of the calibrated zero, doing a pseudo-random walk around the real zero at a much lower frequency than flicker noise. In piezoelectric-based IMUs this can for example be caused by electrical current instability, interference from other electronic components, or subtle changes in temperature. Zero-rate is measured in maximum DPS of deviation the sensor could reach away from the calibrated zero, and DPS/C° for changes in temperature. For commercially available ARSs these may be in the range of milli-degrees per second but aggregated over time these can lead to much greater values. For the application of computer input, this is a big shortcoming of ARSs compared with alternative methods such as optical mouse, which similarly to noise, may have inexistent or negligible drift.

Zero-rate drift may be reduced using one or more of the following techniques:
Acceleration: By applying an exponential response curve, the parts of the signal with low amplitude are reduced further, including noise. In applications in which linearity is required to achieve consistent results this may be an undesired trade-off.
Self-correction: With software, when a constant angular rate is detected for several consecutive seconds, it can be assumed it is not real input and the sensor can be programmatically calibrated.
Sensor Fusion: Using the data from other sensor mechanisms or types, such as magnetometers, such drift can be learned and mitigated.

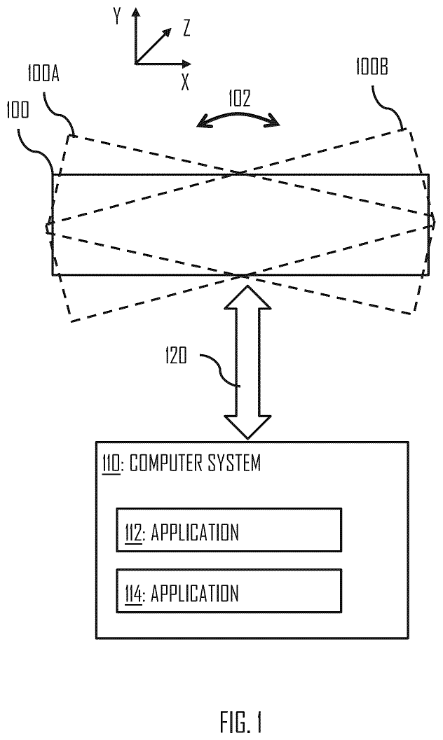

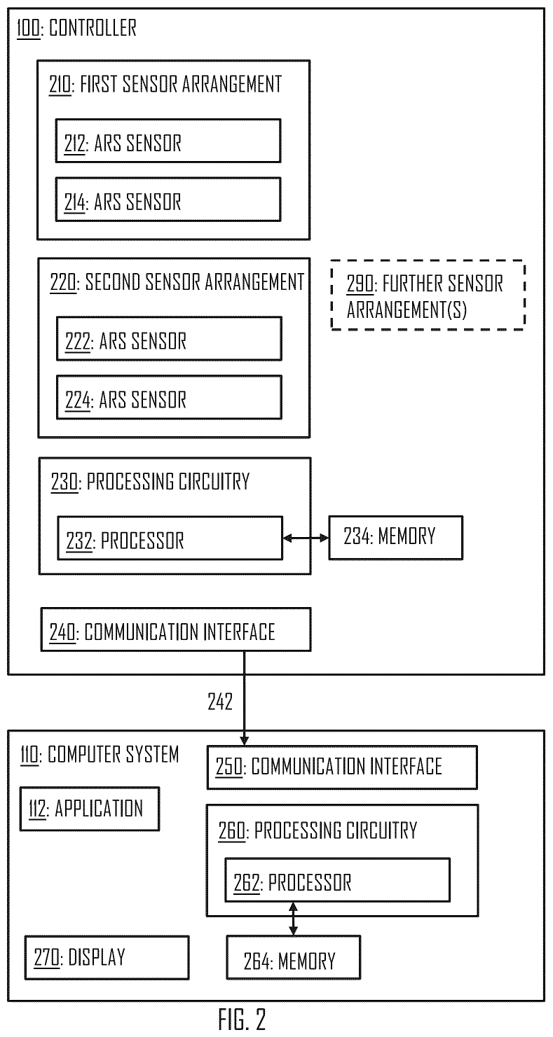

To mitigate at least some of the shortcomings of controllers utilizing angular rate measurement, a solution is proposed in which simultaneous measurement by multiple sensors is utilized to generate a control signal. FIGS. 1 and 2 illustrate examples of a system which comprises controller 100 and computer system 110. Computer system 110 may be external to the controller, meaning that it may not be comprised in the controller 100. Computer system 110 should be seen as an example; other similar types of systems may be controlled by using the described controller 100.

Referring to FIG. 1, the controller 100 may be or be comprised in a game controller, drone controller, remote controller, or computer mouse to name a few examples. In general, the controller 100 may be understood as a Human Interaction Device (HID). Controller 100 may be human operable meaning that the controller 100 may be used by a human user (or simply user). The user may tilt or turn the controller in at least one direction. Skilled person understands such tilting or turning may be performed in one, two, or three directions as depicted by coordinate system X, Y, Z in FIG. 1. Thus, the controller 100 may be turned or tilted around one, two, or three axes. For the sake of simplicity, the following examples are mostly described with the assumption that the tilting or turning is performed around one axis, but as described, the following solution is applicable for measuring turns or tilts around two or three axes.

As shown in FIG. 1, tilting or turning the controller 100 may cause the pose or position of the controller to change (shown with dotted blocks 100A, 100B). As the controller 100 is turned or tilted by the user around an axis, angular rate 102 for said axis may be measured using two or more sensors. Such sensors may include angular rate sensor and/or gyroscope. That is, the controller 100 may measure angular rate of the controller 100 as it moves around said axis or multiple axes.

The controller 100 may be communicatively coupled with the computer system 110 as shown with an arrow 120. This coupling may be enabled with suitable communication interfaces. The communication between the controller 100 and the computer system 110 may be bidirectional or unidirectional. For example, the controller 100 may transmit control signals to the computer system without expecting any feedback; or the controller 100 may expect feedback related to transmitting the control signal (e.g. haptic feedback signal) or for some other purpose. Computer system 110 may execute one or more applications 112, 114. For example, the control signal(s) transmitted by the controller 100 may be used to control the operation or execution of the one or more applications (for example a computer application).

Now referring to FIG. 2 and particularly to the controller 100, the controller 100 may comprise a first sensor arrangement 210 for measuring angular rate of the controller 100 for at least one axis to provide a first measurement data; a second sensor arrangement 220 for measuring angular rate of the controller 100 for said at least one axis (i.e. the same axis or same axes) to provide a second measurement data; a processing circuitry 230 for generating a control signal representing angular rate of the controller 100 for said at least one axis based on the first measurement data and the second measurement data; and a communication interface 240 for coupling with an external computer system 110 and for providing the control signal 242 to the external computer system 110 to control an application 112 run on the computer system 110.

The first first sensor arrangement 210 may comprise at least one sensor 212, 214 for measuring angular rate of the controller 100. Similarly, the second sensor arrangement 220 may comprise at least one sensor 222, 224 for measuring angular rate of the controller.

In an embodiment, the sensor 212, 214, 222, 224 is or comprises an angular rate sensor (ARS).

In an embodiment, the sensor 212, 214, 222, 224 is or comprises a gyroscope.

Thus, a sensor arrangement as described herein may comprise one or more sensors wherein the one or more sensors comprise at least one ARS and/or at least one gyroscope.

In a further embodiment, the controller 100 comprises one or more further sensor arrangements 290. Sensor arrangement 290 may be understood to be similar as described with reference to arrangements 210 and/or 220. As one example, if first and second sensor arrangements 210, 220 are configured to measure angular rate for a first axis, the further sensors arrangement(s) may be configured to measure angular rate for a second and/or third axes. However, in some examples, the arrangements 210, 220 are configured to measure angular rate for two or more axes. For this purpose, one or more sensors for each axis may be used. On the other hand, one sensor may have a capability to measure angular rate for more than one axis. In general, the controller 100 may comprise two or more sensors for measuring angular rate for each axis that is configured to be measured.

In an embodiment, said at least one axis comprises a plurality of axes. That is, the controller 100 (e.g. arrangements 210, 220) is configured to measure angular rate for first axis, second axis, and/or third axis.

In an embodiment, each sensor arrangement 210, 220 comprises at least one sensor for each of the plurality of axes. For example, sensors 212 and 222 may be configured to measure angular rate for first axis and sensors 214, 224 may be configured to measure angular rate for second axis. As one example, the sensors 212 and 214 may be arranged perpendicular to each other. Similarly, sensors 214 and 224 may be arranged perpendicular to each other. Similar logic may apply if third axis is measured with the help of further sensors. In such case, the controller 100 may comprise at least three sensors arranged perpendicular to each other, for example.

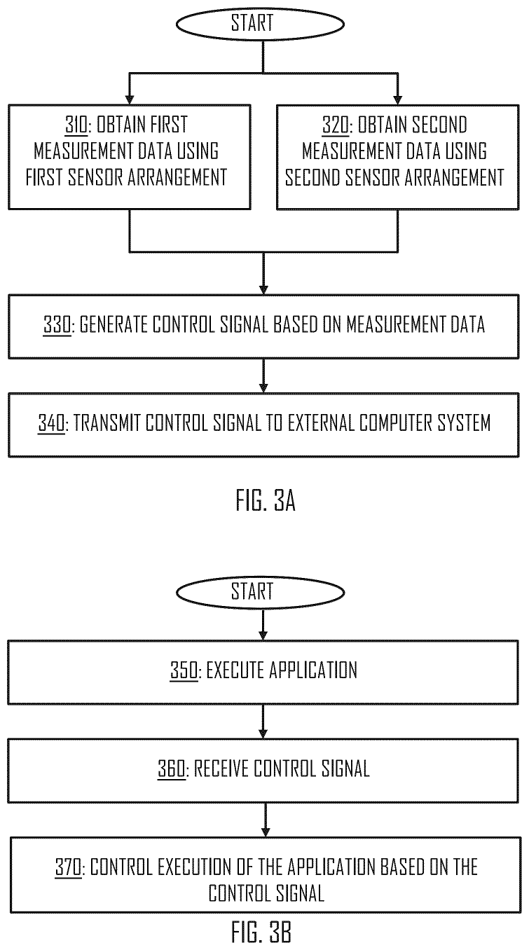

FIG. 3A illustrates a block diagram of a method performed by the controller 100 according to an example embodiment. Referring to FIG. 3A, the process starts and in blocks 310, 320 the controller obtains first measurement data and second measurement data using the first sensor arrangement 210 and second sensor arrangement 220 respectively. Blocks 310, 320 may be performed simultaneously. That is, the arrangements 210, 220 may be configured to measure angular rate for the same axis or axes simultaneously. The arrangements 210, 220 may further be configured to provide the measurement data to the processing circuitry 230. If further arrangement(s) 290 are used, similar logic may apply to the measurements performed by said further arrangement(s).

In block 330, the controller 100, using e.g. the processing circuitry 230, may generate the control signal based on the measurement data obtained in blocks 310, 320.

In block 340, the controller 100, using e.g. the communication interface 240, may transmit the generated control signal to the external computer system 110. The control signal transmission is shown in FIG. 2 with an arrow 242.

As described above, the controller 100 may comprise a processing circuitry 230. Such circuitry may be implemented with an FPGA (field-programmable gate array) or ASIC (application specific integrated circuit) circuitry, or it may be implemented with at least one processor 232 coupled with at least one memory 234 of the controller. For example, the memory 234 may include software (computer program code) that when executed by the processor 232 causes the performance of the controller 100 (e.g. performing steps of FIG. 3A).

The communication interface 240 may enable the transmittance of the control signal 242 to the computer system 110. The communication interface 240 may be configured to enable wired (such as universal serial bus (USB) or local area network (LAN)) and/or wireless (such as Bluetooth, Wireless LAN (WLAN)) data transfer. These need to be understood as examples, and other wired or wireless communication methods may be used to transmit the control signal from the controller 100 to the computer system 110.

Referring still to FIG. 2, the computer system 110 may also comprise a communication interface 250 enabling at least the reception of the control signal from the controller 100. Interface 250 may be configured to receive wired and/or wireless data transmissions.

Further, the computer system 110 may comprise a processing circuitry 260 for causing performance of the computer system. For example, the processing circuitry may be FGPA or ASIC, or the processing circuitry 260 may comprise at least one processor 262 coupled with at least one memory 264 of the computer system. For example, the memory 264 may include software (computer program code) that when executed by the processor 262 causes the computer system 110 (e.g. performing steps of FIG. 3B) to perform accordingly.

In an embodiment, the memory 264 stores application 112 and/or one or more applications 114. Thus, the processing circuitry 260 may execute the stored application 112. In yet another embodiment, the computer system comprises a display 270 for displaying content of the application 112.

The memory or memories discussed herein may be implemented using any suitable data storage technology, such as semiconductor-based memory devices, flash memory, magnetic memory devices and systems, optical memory devices and systems, fixed memory and removable memory. The memory may comprise a database for storing data.

The processing circuitry 260 may process the received control signal 242 and control the application 112 based on the processed control signal 242. For example, the processing circuitry 260 may determine magnitude and/or direction of movement change to be caused to or via the application 112 based on the processed control signal. In another embodiment, the received control signal is provided by the computer system 110 directly to the application 112 (i.e. received raw control signal), wherein the application 112 is configured to determine an action to be performed based on the received control signal.

FIG. 3B illustrates methods steps performed by the computer system 110 according to an example embodiment. In block 350, the computer system 110 executes the application 112. In block 360, the computer system 110 receives the control signal 242 from the controller 100. In block 370, based on the received control signal, the computer system controls the execution of the application 112. Controlling the execution of the application 112 may comprise e.g. movement command (moving a drone or pointer on the display 270) or some other action.

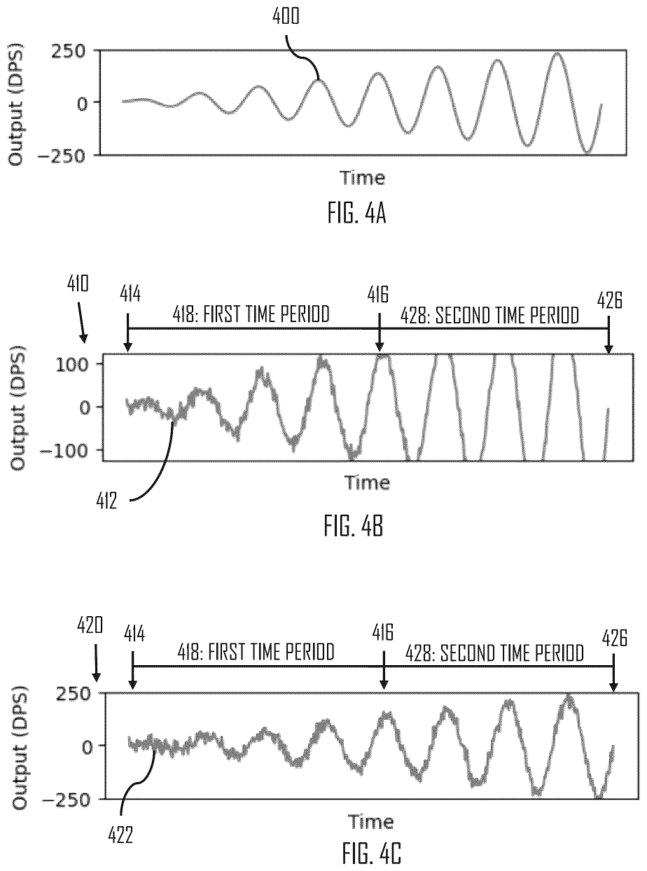

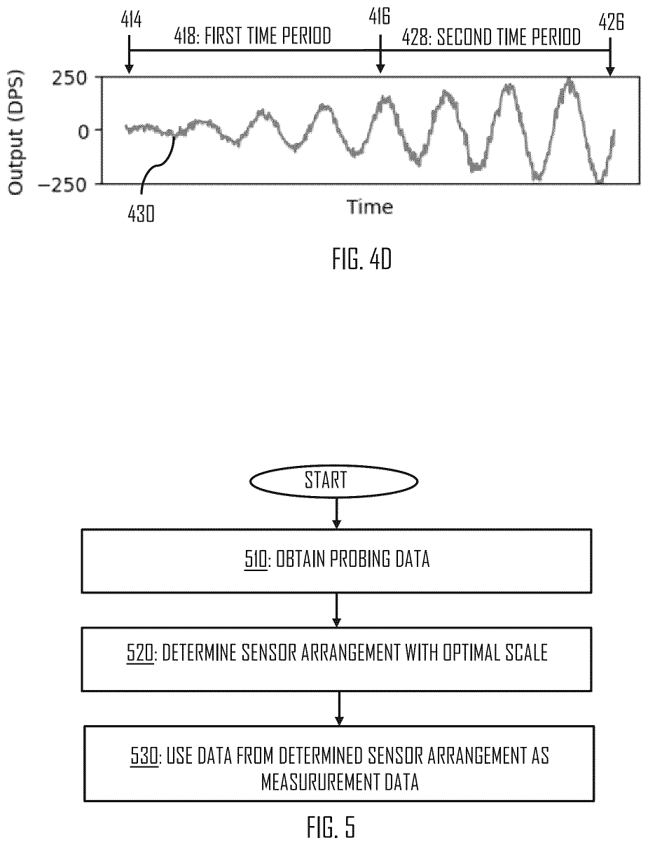

Let us then draw our attention to some embodiments with the help of FIGS. 4A, 4B, 4C, 4D, and 5 which relate to utilizing different scales for the different sensor arrangements, such as for the arrangements 210, 220. Referring first to FIG. 4A, an actual angular rate as function of time is illustrated with curve 400 (referred to also as actual input). Angular rate may be indicated in DPS. As shown in FIG. 4A, magnitude of the actual input changes quite a lot during the observation period. Smaller sensor scale or sensing scale may be beneficial in measuring the actual input as accurately as possible, but on the other hand it may not be possible to measure the actual input during time periods when the actual input does not fit the sensor scale or sensing scale. Changing the scale dynamically with a single sensor may be problematic as it may generate unwanted latency. However, by using multiple sensors each one adjusted to a different scale, and then using the output of the most suitable sensor (the one with the smaller scale able to fit the input without saturation) a result with lower noise and lower zero-rate may be obtained when the input is small, but with less limitations in range when the input is greater.

Accordingly, in an embodiment, the first sensor arrangement 210 is configured to measure angular rate of the controller 100 with a first sensing scale, and the second sensor arrangement 220 is configured to measure angular rate of the controller 100 with a second sensing scale larger than the first sensing scale. First sensing scale is shown in FIG. 4B with arrow 410 and second sensing scale in FIG. 4C with arrow 420. In the examples, first sensing scale is −125-125 DPS and second sensing scale is −250-250 DPS.

In an example embodiment, the first sensing scale 410 and the second sensing scale 420 are fixed during obtaining the first measurement data and the second measurement data. For example, the controller 100 may configure the sensing scales 410, 420 to be fixed for a certain time period (e.g. observation window). Such configuration may be performed e.g. by the processing circuitry 230 using one or more software commands. However, the scales 410, 420 may be adjustable for different time periods. Thus, the sensing scales 410, 420 should be understood to be fixed for a limited time period based on controller 100 determination. Accordingly, the controller 100 may determine to change one or both of the scales 410, 420 (and/or scale of some other sensor arrangement) for a different time period. However, it may make sense to fix the scales 410, 420 for a certain time period (i.e. when obtaining the first and second measurement data) so that the scale change does not cause any latency to the measurement. One trigger for scale change may be that if the actual input does not fit inside any of the used sensing scales, the controller 100 may trigger the scale change for one or both of the sensor arrangements 210, 220. It needs to be noted that the scale change may be sensor specific. I.e. if sensor arrangement comprises more than one sensor, the scale change may be performed per sensor as needed. For example, controller 100 may determine to change sensing scale of sensor 212, but not sensing scale of sensor 214. This may be beneficial e.g. if said sensors 212, 214 are configured to measure different axes: one axis may require the change, but the other may not. These should be understood as examples of the possible implementation.

In another example embodiment, the first and second sensing scales 410, 420 are fixed. In this example, the sensors are inherently configured to measure angular rate with certain fixed scales. This may be beneficial for the simplicity of the system: that is, the sensors permanently fixed to a certain scale may be e.g. easier and/or cheaper to manufacture compared with the sensors which have capability for dynamic scale adjustment. For example, each arrangement 210, 220 may comprise two or more sensors each with a different scale. If for example sensor 212 cannot provide data for the whole needed measuring range, a different sensor 214, with larger scale, may be selected by the controller 100. Thus, both sensor arrangements may provide valid measurement data.

Referring to FIG. 4B, the controller 100 may be configured to utilize at least the first measurement data associated with the first sensing scale 410 smaller than the second sensing scale 420 in generating the control signal if the measured angular rate does not exceed the first sensing scale 410. From FIG. 4B we can see that such condition is true during first time period 418 (between time instants 414 and 416). Thus, as the actual input 400 fits inside the first sensing scale 410, the controller 100 uses the first measurement data from the first sensor arrangement 210 to generate the control signal. The benefit in such a case is that the first measurement data obtained with a smaller sensing scale may be more accurate compared with the second measurement data.

In an example embodiment, the controller 100 additionally utilizes the second measurement data for generating the control signal.

In another embodiment, the controller 100 is configured to utilize the first measurement data but not the second measurement data in generating the control signal if the measured angular rate does not exceed the first sensing scale 410. Thus, in this embodiment, the processing circuitry 230 may determine the control signal only based on the first measurement data, and thus exclude the use of second measurement data (e.g. for the first time period 418). It is noted that the first measurement data may be obtained using one or more sensors. The same logic applies to obtaining the second measurement data. If more than one sensor is used to obtain the first measurement data, it may be beneficial that all sensors arranged to measure the same axis are configured with the same sensing scale. Same logic applies to the second measurement data.

On the other hand, if the measured angular rate exceeds the first sensing scale 410, the controller 100 is configured to utilize the second measurement data associated with the second sensing scale 420 but not the first measurement data in generating the control signal. As can be seen in FIG. 4B, the measured signal 412 (represented by the first measurement data) exceeds the first sensing scale 410 multiple times during second time period 428 (between time instants 416 and 426). In other words, the measured angular rate (i.e. measured with the first sensor arrangement 410) saturates to the limit(s) set by the sensing scale. Thus, at least when the actual input 400 exceeds the first sensing scale 410, the controller 100 is configured to utilize and utilizes the second measurement data, but not the first measurement data. In FIG. 4C, we can observe that the second sensing scale 420 does fit the whole measured signal 422 represented by the second measurement data.

Referring to FIG. 4D, the controller 100 may generate the control signal based on angular rate signal 430 which is generated based on the first measurement data (or signal 412) and the second measurement data (or signal 422). The angular rate signal 430 may be combination of the signals 412 and 422.

In an embodiment, the angular rate signal 430 is the control signal (e.g. 242).

As can be seen in FIG. 4D, now the angular rate signal 430 is more accurate than signal 422 alone (i.e. less noise), but also captures the actual input 400 during those time instants or time periods when signal 412 does not fit the first sensing scale 410 (i.e. when signal 412 saturates because of too small sensing scale).

There may be different ways to combine the first measurement data and second measurement data to obtain the angular rate signal 430. In an embodiment, the controller 100 is configured to: determine, based on the first measurement data, a first time period 418 during which the measured angular rate does not exceed the first sensing scale 410; based on the determining, utilize at least the first measurement data (or only the first measurement data) in generating the control signal for the first time period 418; determine, based on the first measurement data or the second measurement data, a second time period 428 during which the measured angular rate exceeds the first sensing scale 410; and based on the determining, utilize the second measurement data but not the first measurement data in generating the control signal for the second time period 428. This may make sense since when it is determined that the first sensing scale 410 is too small, it may be beneficial to change the measurement data source to a sensor with larger sensing scale as it is difficult to know when the actual input 400 drops to a level that is possible to capture with the smaller sensing scale.

However, as the signal 412 may saturate only at certain time occasions or sub-time periods during the second time period, it may alternatively be possible to utilize the first measurement data as primary data for generating the control signal during both periods 418, 428, and to utilize the second measurement data only when the signal 412 does not fit the first sensing scale 410, but not for the whole time period 428.

Accordingly, the controller 100 may be configured in some embodiments to determine that measured angular rate exceeds the first sensing scale 410 of the first sensor arrangement 210, and based on the determination, change from using the first measurement data to generate the control signal to using the second measurement data (i.e. obtained using the second sensor arrangement 220 with second sensing scale 420) to generate the control signal. It is noted at this point that, in some examples, both sensor arrangements 210, 220 may be configured to continuously measure angular rate according to the configuration, but the processing circuitry 230 may select which of the measurement data (or both) to use in generating the control signal.

In another embodiment, the controller 100 is configured to determine that measured angular rate does not exceed the first sensing scale 410 of the first sensor arrangement 210. Based on the determination, the controller 100 may change from using the second measurement data (i.e. obtained using the second sensor arrangement 220 with second sensing scale 420) to generate the control signal to using the first measurement data (i.e. obtained using the first sensor arrangement 210 with first sensing scale 410) to generate the control signal. This may be beneficial, for example, because first sensing scale 410 may be more accurate than the second sensing scale 420. In another embodiment, if the controller 100 is already using the first measurement data, it may continue using the first measurement data based on the determination. However, if the controller 100 is not using the first measurement data and instead uses the second measurement data, it may change from using the second measurement data to using the first measurement data based on the determination. This may lead to better accuracy of the measurement as the larger scale (i.e. more inaccurate scale) is disregarded. In yet another example, if the measured angular rate (determined based on one or more of the sensor arrangements) is determined to fit the first and second sensing scales, the controller 100 may use both the first and second measurement data for generating the control signal. This may help to enhance the accuracy and/or robustness of the measurement.

Referring to FIG. 5, a block diagram is shown which illustrates an example on how to determine that the actual input 400 exceeds the first sensing scale (i.e. the smaller or smallest sensing scale available for the controller 100).

In block 510, the controller 100 obtains probing data. In an example embodiment, the probing data includes first measurement data and/or second measurement data.

In block 520, the controller 100 may determine sensor arrangement with optimal scale for providing measurement data to be used for generating the control signal. For example, if first measurement data is used as the probing data, the controller 100 may determine whether or not the measured signal 412 exceeds the limit(s) set by the sensing scale 410. If limit(s) are not exceeded, the controller 100 may select first sensor arrangement 210. If limit(s) are exceeded, the controller 100 may select another sensor arrangement, such as the second sensor arrangement 220, with a larger scale.

In another example, second measurement data may be used as probing data. In this case, the controller 100 may, for example, compare measured signal 422 with first sensing scale 410. Based on the comparison, the controller 100 may determine whether to use first or second sensor arrangement following similar logic as indicated above.

In yet another example, both of the first and second measurement data may be used as probing data. This may bring the benefit of verifying that the measured signal(s) 412, 422 represents the actual input 400 accurately enough. For example, basing the sensor selection only on one probing data set may cause problems if the measured data comprises errors. Thus, for example, the controller 100 may select the first sensor arrangement only if both first and second measurement data indicate that the actual input 400 fits inside the first sensing scale 410. Otherwise, the second sensor arrangement 420 may be selected.

In a further example, the probing data comprises previous data-set and/or the previous data-set is used as the probing data. The previous data-set may comprise data from one or both of the first sensor arrangement and second sensor arrangement. Previous herein may refer to data-set that is obtained before the current measurement, possibly referring to the last data-set that was obtained before the current measurement.

Determining or selecting the sensor arrangement with optimal scale (see step 520) may additionally or alternatively comprise selecting a sensor arrangement with smaller scale. I.e. the sensor arrangement(s) with smaller scale may be preferred. Additional condition here may be that the measured signal 412 should be able to fit inside the scale of the selected sensor arrangement. Thus, if a sensor arrangement (e.g. first sensor arrangement 410) having a certain sensing scale, in some examples, all other remaining sensor arrangements that have larger scale(s) (than the sensor arrangement that was selected) may be disregarded in the selection (i.e. not selected and their data may not be used).

In block 530, the controller 100 may utilize measurement data from the determined sensor arrangement to generate the control signal. In this example, only one sensor arrangement from the first and second arrangements 210, 220 may be selected. Thus, for example, only one sensor (e.g. of arrangement 210 or 220) may be selected as data source for determining the control signal representing angular rate of the controller 100 for one axis.

In some examples, given a system with multiple sensors and their measurement S₁ . . . Sₙ, each sensor with a range R₁ . . . Rₙ and configured to measure the angular rate around the same axis simultaneously, and sorted from greater to smaller range, the final output (e.g. signal 430 or similar if more than two sensors are used) can be defined for example as:

$$Output = \{ \begin{matrix}if ( {S}_{1} \leq {R}_{1} ) \to {S}_{1} / {R}_{1} \\ else if ( {S}_{2} \leq {R}_{2} ) \to {S}_{2} / {R}_{2} \\ … \\ else if ( {S}_{n - 1} \leq {R}_{n - 1} ) \to {S}_{n - 1} / {R}_{n - 1} \\ else {S}_{n} / {R}_{n}\end{matrix}$$

As we can see, it is possible to use two or more sensors (e.g. ARS or gyroscope) and prefer selecting (by the controller 100) the sensor which has the smallest suitable scale for providing measurement data for generating the control signal. Smallest suitable scale may mean the smallest available scale that can fit the measured angular rate. As time passes, the selection may change as the amplitude of the actual input changes as discussed above.

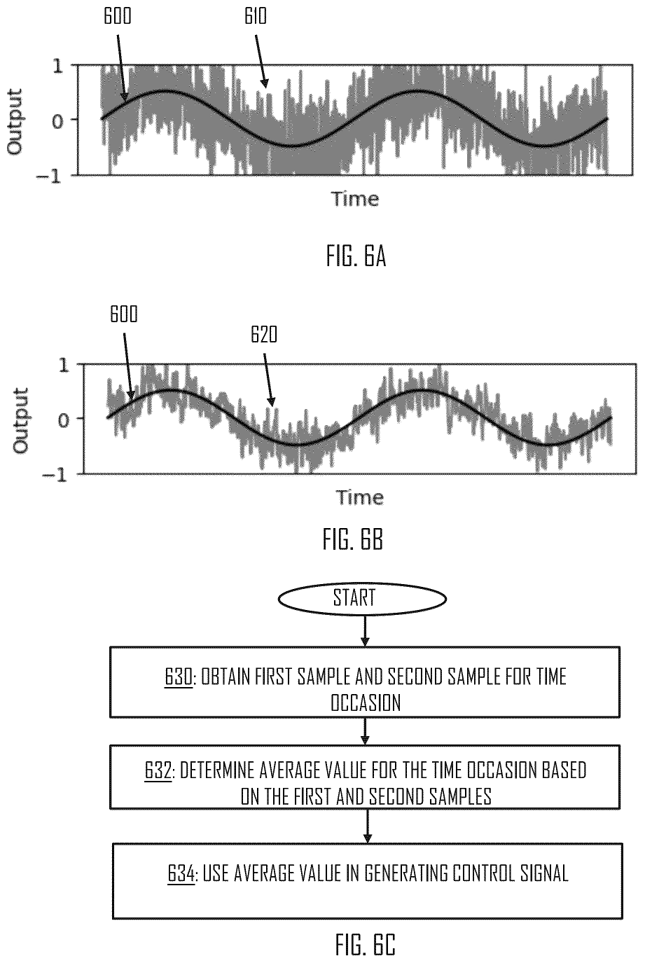

Let use the look closer on FIGS. 6A and 6B. FIG. 6A shows an actual input signal 600 (similar as described above) and plurality of samples 610 measured with only one sensor. In this example, only one sample 610 is measured for each measurement occasion (or time instant). Thus, we can see that the results include a lot of noise.

In FIG. 6B, still using only one sensor, the noise can be reduced by performing multisampling. This means that for a measurement occasion, multiple samples 620 are measured. Specifically in this example, the same input signal 600 is measured by taking four samples 620 for each measurement occasion. As we can observe, the noise is significantly reduced. However, latency increases as the number of samples increases:

$$Latency = \frac{Samples}{S e n s o r s}$$

Based on the formula above, latency is four times higher than in the example of FIG. 6A when four samples for each measurement occasion are measured.

By using multiple physically connected sensors, is possible to take samples in parallel and average their values without increasing latency. The following formula is an example on how to obtain average values for measurement occasions:

$$f ( t ) = \frac{A v g ( {x}_{1} , y ) + A v g ( {x}_{2} , y ) … + A v g ( {x}_{n} , y )}{N}$$

where t denotes time,
where xₙ denotes sensor with index n (n=1, 2, . . . N),
where y denotes number of samples (one or more samples), and
where N denotes number of sensors.

Averaging function Avg(xₙ, y) may output average of sensor with index n at time t with y number of samples. Thus, f(t) with a given value for t may denote average value at a certain measurement occasion (i.e. measurement occasion at t). Thus, using the described function, averaged samples may be obtained for the duration of the measurement period.

Averaging the values, as in the example above, may be just one possibility or example. More complex operations are possible, and the accuracy and drift tendencies may also be learned and/or stored and taken into account in subsequent computations/calibrations.

It is noted that the example using multiple sensors for multisampling assumes that sensors scales are the same. If sensors with different scales are used, the averaging may need to take this into account. Therefore, if different scales are used, the controller 100 may need to perform scaling operation on the average values from sensors with different scales before obtaining the final output f(t).

FIG. 6C illustrates an example embodiment on obtaining average value(s) from multisampling using multiple sensors. The controller 100 may, based on the first measurement data, obtain at least one first sample associated with a time occasion; based on the second measurement data, obtain at least one second sample associated with said time occasion (block 632); determine an average value for the time occasion based on the at least one first sample and at least one second sample (block 632); and utilize the average value for said time occasion in generating the control signal (block 634).

As discussed, for each time occasion (or measurement occasion), one or more samples from each sensor used may be obtained. Accordingly, the controller 100 may further determine, based on the first measurement data and second measurement data, a plurality of average values for different time occasions; and utilize the plurality of average values in generating the control signal.

Generating the control signal may be based on the plurality of averaged values (e.g. see example above using the described function). Example of averaged values based on actual input 600 may be shown in FIG. 6D. In the example, multiple sensors are used to capture multiple samples for each measurement occasion, and further the averaged multiple samples from each sensor are further averaged based on the number of sensors used. Thus, a series of averaged values 640 may be obtained. For example, if eight samples for each measurement occasion are obtained using two sensors, latency would be the same as if multisampling with four samples would have been done with only one sensor. For example, the sensors may be arranged to measure same axis or axes. Thus, the multiple samples may represent measurement result from the same axis, and thus the averaged samples may represent the average measurement result for the same axis.

Increasing the number of samples may reduce noise and increasing number of sensors used to measure said samples may decrease latency. Thus, the described multisampling with multiple sensors may provide higher accuracy control signal with acceptable latency. The conclusion is that redundant sensors (of equal or similar characteristics) can be used to either reduce total noise more effectively within the same latency, or to achieve the same level of noise reduction but with less latency.

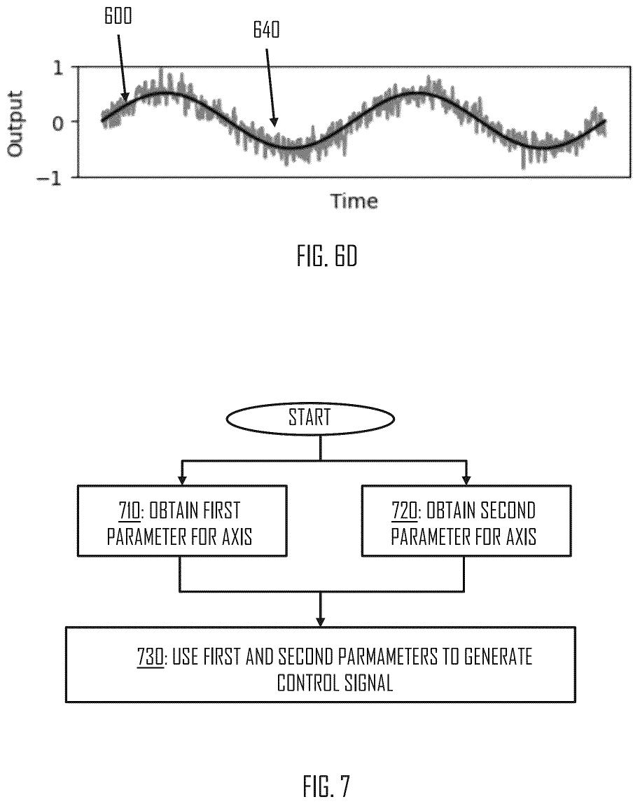

FIG. 7 illustrates an embodiment related to averaging output signals from multiple sensors. Instead of averaging samples in multisampling using multiple sensors, it may be possible to obtain output signals from each used sensor and average those output signals to generate the control signal. This procedure may help in decreasing the effect of zero-rate drift. Referring to the example of FIG. 7, the controller 100 may be configured to obtain, based on the first measurement data, a first parameter representing angular rate of the controller for said at least one axis (block 710); obtain, based on the second measurement data, a second parameter representing angular rate of the controller for said at least one axis (block 720); and generate the control signal by averaging first and second parameters (block 730).

In an embodiment, the first parameter and second parameter represent angular rate of the controller on the same axis.

In at least some embodiments as described herein, the at least one axis may refer to the same one or more axis that is/are measured using multiple sensors. In simplest form, for example, the at least one axis may refer to one (i.e. single) axis that is measured (and possibly simultaneously) with two or more sensors. For example, thus it the controller may obtain the first and second parameters.

Blocks 710 and 720 may be performed in parallel (i.e. simultaneously), for example.

First parameter and second parameter may refer to first intermediate control signal and second intermediate control signal, respectively. So, for example, both sensor arrangements 210, 220 may be used to obtain intermediate control signals. Finally, the intermediate control signal may be averaged to obtain the control signal which is transmitted to the computer system 110.

It is noted that averaging the samples or signals are just some of the examples for which the present solution may be applied. For example, more complex operations may be performed, and the accuracy and drift tendencies can also be learned and/or stored (e.g. in the memory of the controller 100) and taken into account in subsequent computations and/or calibrations.

In an embodiment, an apparatus (such as the controller 100) carrying out at least some of the embodiments described comprises at least one processor and at least one memory including a computer program code, wherein the at least one memory and the computer program code are configured, with the at least one processor, to cause the apparatus to carry out the functionalities according to any one of the embodiments described. For example, the at least one processor, the memory, and the computer program code form processing means for carrying out at least some of the embodiments described. According to yet another embodiment, the apparatus carrying out at least some of the embodiments comprises a circuitry including at least one processor and at least one memory including computer program code. When activated, the circuitry causes the apparatus to perform the at least some of the functionalities according to any one of the embodiments described.

As used in this application, the term ‘circuitry’ refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

In an embodiment, at least some of the processes described may be carried out by an apparatus (such as the controller 100) comprising corresponding means for carrying out at least some of the described processes. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein.

Embodiments as described may also be carried out in the form of a computer process defined by a computer program or portions thereof. Embodiments of the methods described may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. For example, the computer program medium may be a non-transitory medium.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. A human operable controller for converting angular rate of the controller into a control signal for controlling an application run on an external computer system, the controller comprising:
a first sensor arrangement for measuring angular rate of the controller for at least one axis to provide a first measurement data;
a second sensor arrangement for measuring angular rate of the controller for said at least one axis to provide a second measurement data;
a processing circuitry for generating a control signal representing angular rate of the controller for said at least one axis based on the first measurement data and the second measurement data; and
a communication interface for coupling with the external computer system and for providing the control signal to the external computer system to control the application.

2. The controller of claim 1, wherein the first sensor arrangement is configured to measure angular rate of the controller with a first sensing scale, and the second sensor arrangement is configured to measure angular rate of the controller with a second sensing scale different from the first sensing scale.

3. The controller of claim 2, wherein the first sensing scale and second sensing scale are fixed during obtaining the first measurement data and the second measurement data.

4. The controller of claim 2, wherein the processing circuitry is configured to:
utilize at least the first measurement data associated with the first sensing scale smaller than the second sensing scale in generating the control signal if the measured angular rate does not exceed the first sensing scale.

5. The controller of claim 4, wherein the processing circuitry is configured to:
utilize the first measurement data but not the second measurement data in generating the control signal if the measured angular rate does not exceed the first sensing scale.

6. The controller of claim 4, wherein the processing circuitry is configured to:
if the measured angular rate exceeds the first sensing scale, utilize the second measurement data associated with the second sensing scale but not the first measurement data in generating the control signal.

7. The controller of claim 2, wherein the processing circuitry is configured to:
determine, based on the first measurement data, a first time period during which the measured angular rate does not exceed the first sensing scale;
based on the determining, utilize at least the first measurement data in generating the control signal for the first time period;
determine, based on the first measurement data, a second time period during which the measured angular rate exceeds the first sensing scale; and
based on the determining, utilize the second measurement data but not the first measurement data in generating the control signal for the second time period.

8. The controller of claim 1, wherein the processing circuitry is configured to:
based on the first measurement data, obtain at least one first sample associated with a time occasion;
based on the second measurement data, obtain at least one second sample associated with said time occasion;
determine a value for the time occasion based on the at least one first sample and at least one second sample; and
utilize the determined value for said time occasion in generating the control signal.

9. The controller of claim 8, wherein the processing circuitry is configured to:
determine, based on the first measurement data and second measurement data, a plurality of values for different time occasions; and
utilize the plurality of values in generating the control signal.

10. The controller of claim 1, wherein the processing circuitry is configured to:
obtain, based on the first measurement data, a first parameter representing angular rate of the controller for said at least one axis;
obtain, based on the second measurement data, a second parameter representing angular rate of the controller for said at least one axis; and
generate the control signal based on first and second parameters.

11. The controller of claim 1, wherein the first sensor arrangement comprises at least one of an angular rate sensor or a gyroscope, and the second sensor arrangement comprises at least one of an angular rate sensor or a gyroscope.

12. The controller of claim 1, wherein said at least one axis comprises a plurality of axes.

13. The controller of claim 12, wherein each sensor arrangement comprises at least one sensor for each of the plurality of axes.

14. A method for a controller for converting angular rate of the controller into a control signal for controlling an application run on an external computer system:
measuring, using a first sensor arrangement, angular rate of the controller for at least one axis to provide a first measurement data;
measuring, using a second sensor arrangement, angular rate of the controller for said at least one axis to provide a second measurement data;
generating, using a processing circuitry, a control signal representing angular rate of the controller for said at least one axis based on the first measurement data and the second measurement data; and
providing, using a communication interface, the control signal to the external computer system to control the application.

15. A system comprising:
the controller as claimed in claim 1; and
a computer system external to the controller, wherein the computer system comprises at least one processor and at least one memory including computer program code which when executed by the at least one processor causes the computer system at least to:
execute an application;
receive a control signal from the controller; and
control the execution of the application based on the received control signal.

16. The method of claim 14, wherein the first sensor arrangement is configured to measure angular rate of the controller with a first sensing scale, and the second sensor arrangement is configured to measure angular rate of the controller with a second sensing scale different from the first sensing scale.

17. The method of claim 16, wherein the first sensing scale and second sensing scale are fixed during obtaining the first measurement data and the second measurement data.

18. The method of claim 16, wherein if the measured angular rate does not exceed the first sensing scale, at least the first measurement data associated with the first sensing scale smaller than the second sensing scale is utilized in generating the control signal.

19. The method of claim 18, wherein if the measured angular rate does not exceed the first sensing scale, the first measurement data but not the second measurement data is utilized in generating the control signal.

20. The method of claim 18, wherein if the measured angular rate exceeds the first sensing scale, the second measurement data associated with the second sensing scale but not the first measurement data is utilized in generating the control signal.
